(19) United States
(12) Patent Application Publication
(10) Pub. No.: US 2011/0294107 A1
(43) Pub. Date: Dec. 1, 2011

(54) LEARNING SYSTEM

(75) Inventor: Sharon Wellard, Bowral (AU)

(73) Assignee: Alert Learning Pty Ltd., Bowral (AU)

(21) Appl. No.: 13/011,838

(22) Filed: Jan. 21, 2011

(30) Foreign Application Priority Data
May 25, 2010 (AU) 2010902292

(51) Int. Cl. G09B 25/00

(52) U.S. Cl. 434/365

(57) ABSTRACT

A computer implemented learning system 10 includes a database 20 containing a plurality of structured symbols 12, each symbol 12 being representative of a particular theme selected to enhance multisensory learning by a student. A user interface 14 presents the structured symbols 12 to the student in a form discernible to the student.

### RELATED APPLICATION

This application claims the benefit of and priority to Australian Provisional Application Serial No. 2010902292, filed May 25, 2010, the contents of which are incorporated by reference herein in its entirety.

### BACKGROUND

This disclosure relates, generally, to a learning system and, more particularly, to a learning system which promotes learning of a language, for example, English. The system and method also apply to the learning of other subjects such as arithmetic, mathematics, or the like.

### SUMMARY

In one aspect, there is provided a computer implemented learning system which includes a database containing a plurality of structured symbols, each symbol being representative of a particular theme selected to enhance multisensory learning by a student; and a user interface for presenting the structured symbols to the student in a form discernible to the student.

In this specification, the term “structured symbol” is to be understood, unless the context clearly indicates otherwise, to refer to a symbol which represents a recognizable entity and which is comprehensible to the student. In other words, “structured symbols” are to be understood as symbols which “tell a story” to the student.

The structured symbols may link concepts to the analytical mind and a relationship to an emotional memory. Structured symbols may link symbolism to function to activate the analytical left side of a student's brain while the symbols with a real-world symbolic relationship may activate the emotional right side of the student's brain. Thus, the structured symbols may link and activate physical, emotional and analytical learning. For example, the ears may physically listen to a symbolic story as told through the structured symbols, the eyes may physically see the structured symbols and the body may physically manipulate the structured symbols to link and activate physical, emotional and analytical learning. The system may therefore use the structured symbols to achieve cognitive engagement.

The particular, selected theme may be a personification of the concept to be learnt, the symbols being associated with at least one of parts of the human body, the human body itself and items, such as apparel, which themselves are associated with the human body. Further, the personification of the structured symbols may reflect human characteristics such as strength, fear, concern, or the like.

The personification of the concept to be learned may be supported by the use of a symbolic story, which may be delivered orally, to assist in developing an emotional understanding of the concept being learnt.

In addition, the themes may be colour coded to enhance categorising concepts. The system may integrate the colours with the symbols to enhance retention. For this purpose, the colours may be selected to have particular relationships.

Each structured symbol may comprise a plurality of interrelated components. In one embodiment, the components may relate to a part of the human body, more particularly the skeletal structure of the human body and associated connecting tissue and musculature. The basic component may be a cell, followed by bone marrow, a bare bone, muscles or tendons associated with the bone and bone assemblies as the concept is built up to show the relationship between parts of the concept.

In another embodiment, each structured symbol may be a part of the body such as a hand where bones of the hand represent different aspects of the concept.

In yet a further embodiment, each structured symbol may represent a person. Each “person” symbol may represent a different idea to be conveyed by a piece of text. For example, idea to be conveyed may be informative, imaginative or persuasive. A body of each person symbol may comprise a number of discrete parts, each of which represents a different part of the concept. Specific colours may be applied to the discrete parts of the body to reinforce learning.

The system may comprise a plurality of modules, the modules being able to be used in conjunction with one another or independently of one another, depending on the concept to be taught. In the case of learning a language, the system may comprise seven modules, being: phonics, spelling, reading, comprehension, grammar, writing and editing. Using these modules literacy, language and literature can be taught. Instead, the modules can be used independently of one another when only some aspects of the system are to be taught.

Each module may make use of the personification of concepts and the symbolic representation of the personified concepts.

The user interface may be an electronic display means such as a computer display, a computer controlled projector, or the like on which the symbols can be displayed in a dynamic format. The dynamic display of the symbols enables the action represented by the symbol or a component of the symbol to be emphasised. The symbols may therefore be displayed in the form of electronic slides which are able to be animated. In addition, or instead, the system may comprise cards, or other substrates, on which the symbols are carried with related material.

In a second aspect, there is provided a computer implemented method of learning which includes personifying a concept to be learnt;

representing the personified concept using a plurality of structured symbols to enhance multisensory learning by a student, the structured symbols being stored in a database; and

presenting the symbols to the student in a form discernible to the student using a user interface.

The method may include associating the symbols with at least one of parts of the human body, the human body itself and items which themselves are associated with the human body or which a person would use in a particular environment.

The method may include supporting the personification of the concept to be learned by the use of a symbolic story to assist in developing an emotional understanding of the concept being learnt.

The method may include colour coding the themes to enhance categorising concepts. Further, the method may include integrating the colours with the symbols to enhance retention. The method may include selecting the colours to have particular relationships.

The method may include generating each structured symbol to comprise a plurality of interrelated components. In addition, the method may include applying specific colours to the components of the structured symbol to enhance learning.

The user interface may be an electronic display means and the method may include displaying the symbols on the electronic display means in a dynamic format to enable the action represented by the symbol or a component of the symbol to be emphasised. In addition, or instead, the method may include displaying the symbols and related material on cards.

In a third aspect there is provided a learning system which includes a plurality of structured symbols, each symbol being representative of a particular theme selected to enhance multisensory learning by a student; and a display means for displaying the structured symbols to the student. In a fourth aspect, there is provided a method of learning which includes personifying a concept to be learnt;

representing the personified concept using a plurality of structured symbols to enhance multisensory learning by a student; and displaying the symbols in a form discernible to the student.

### BRIEF DESCRIPTION OF DRAWINGS

In the drawings:

FIG. 1 shows a schematic, block diagram of an embodiment of a computer implemented learning system;

FIG. 2 shows a representation of a colour chart indicating the relationship between various characteristics and the colours used for components of symbols of the system;

FIGS. 3 and 4 show examples of sound cards of the system displaying various symbols;

FIG. 5 shows an example of a spelling slide or card of the system;

FIG. 6 shows examples of spelling symbols used in the system;

FIG. 7 shows a further example of a spelling slide or card of the system using one of the symbols shown in FIG. 6;

FIG. 8 shows another example of a spelling slide or card of the system using some of the symbols shown in FIG. 6;

FIG. 9 shows an example of a punctuation slide or card of the system;

FIG. 10 shows a list of literacy symbols used in the system;

FIGS. 11a-11c show comprehension characters of the system;

FIG. 12 shows an example of a visualisation technique used in the system for representing content quickly and easily;

FIG. 13 shows a list of grammar symbols used in the system;

FIG. 14 shows a grammar slide or card carrying a graphic representation for teaching sentence structure;

FIG. 15 shows a further grammar slide or card for teaching sentence structure;

FIG. 16 shows an example of a parsing slide or card illustrating the use of the grammar symbols to deconstruct a sentence;

FIG. 17 shows an example of a creative writing slide or card illustrating the basic components for a piece of creative writing;

FIGS. 18-23 show examples of slides or cards containing symbols indicating how complex sentences are constructed;

FIG. 24 shows an example of symbol representing a human body which is used in the system to represent the component parts of an essay;

FIG. 25 shows an example of symbol representing a person's hand which is used in the system to represent the component parts of a paragraph of an essay;

FIG. 26 shows an example of symbol representing a person's hand which is used in the system to represent the component parts of an essay; and

FIG. 27 shows an example of an editing slide or card used in the system.

### DETAILED DESCRIPTION OF EXEMPLARY EMBODIMENTS

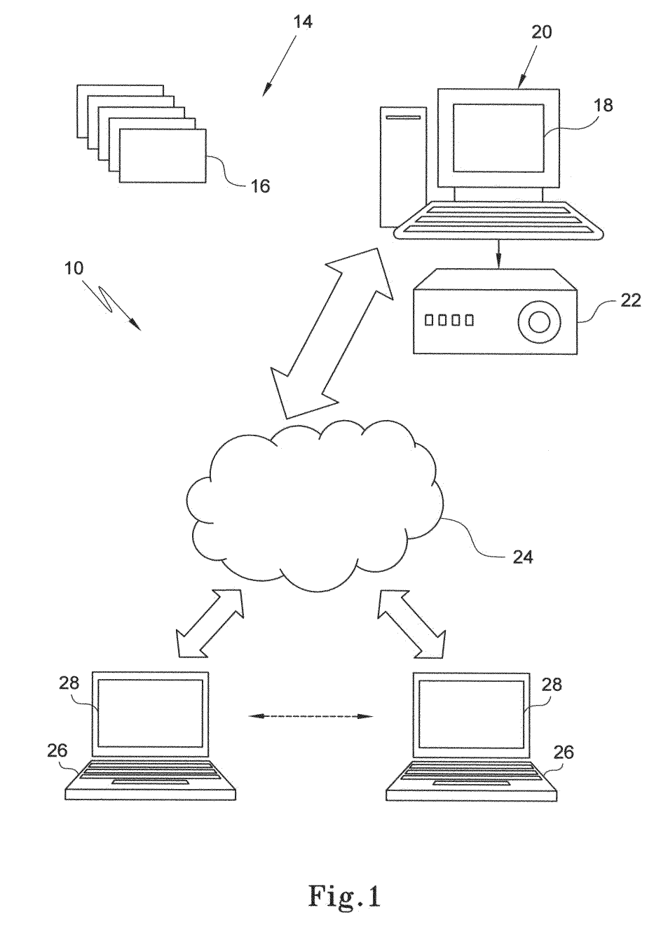

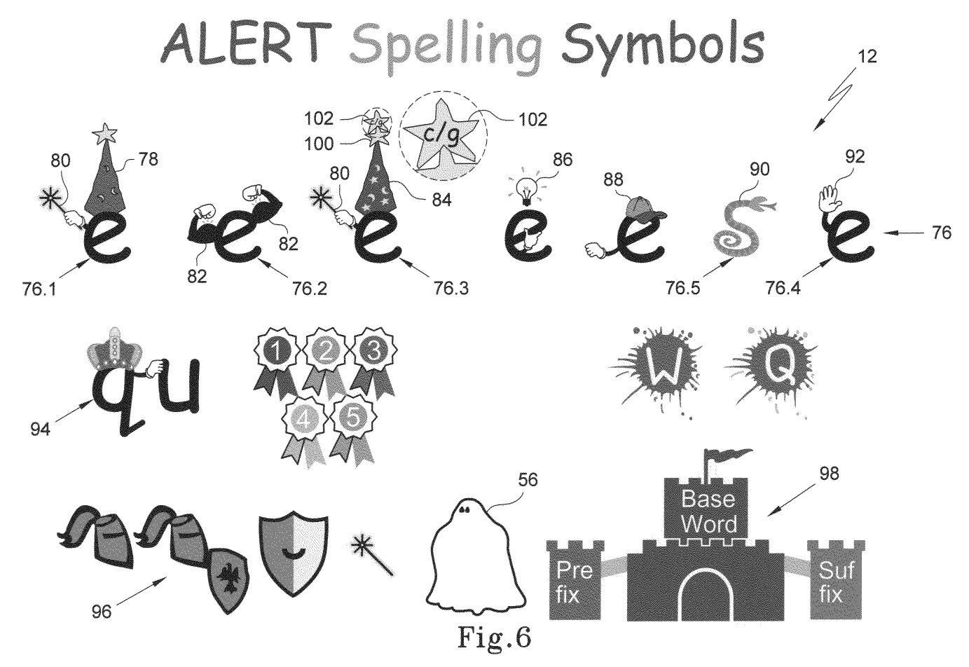

Referring initially to FIG. 1 of the drawings, an embodiment of a computer implemented learning system is illustrated and is designated generally by the reference numeral 10. The system 10 includes a plurality of structured symbols, examples of which are shown at 12 in FIG. 6 of the drawings, each symbol 12 being representative of a particular theme selected to enhance multisensory learning by a student. The system 10 further includes a user interface 14 for displaying the structured symbols, in a suitable context, to the student. The user interface 14 includes, firstly, a display means in the form of a display 18 of a computer 20. The user interface 14 includes, secondly, a plurality of cards or other substrates 16 on which the symbols 12 are carried. The user interface 14 also includes a speaker system of the computer 20 to make at least some of the symbols audibly available to the students.

Further, the computer 20 acts as a database, or may be connected to a separate database (not shown), containing the symbols 12. Components of the symbols 12 can be stored in the database to enable complete symbols 12 to be built up using the relevant components required to convey a particular idea or theme.

The information displayed on the computer display 18 can, for example, comprise electronic slides which are animated and which display the symbols 12 in a dynamic fashion to enhance retention by the students. The computer 20 can, for example, be connected to a projector 22 for projecting electronic slides on to a suitable screen.

In addition, the system 10 can be connected, by way of the internet, designated schematically at 24, to student's computers 26 so that displays 28 of the computers 26 also display the structured symbols 12 in their correct contextual setting. For ease of reference, the various user interfaces described above will be referred to in the description which follows as the “user interfaces” 14.

As indicated, the system 10 is intended to provide multisensory learning to students to teach them certain subjects. While the system 10 has been developed particularly for teaching improved literacy, language and literacy skills in English, it will be appreciated that the system 10 can equally be used for other languages and, in addition, for other subjects such as arithmetic or mathematics.

The system 10, in the case of its application for teaching English, comprises seven modules being a phonics module, a spelling module, a reading module, a comprehension module, a grammar module, a writing module and an editing module. Each of these modules will be described in greater detail below. The modules of the system 10 can be taught independently as stand alone units or combined into a single, integrated approach for the teaching of English.

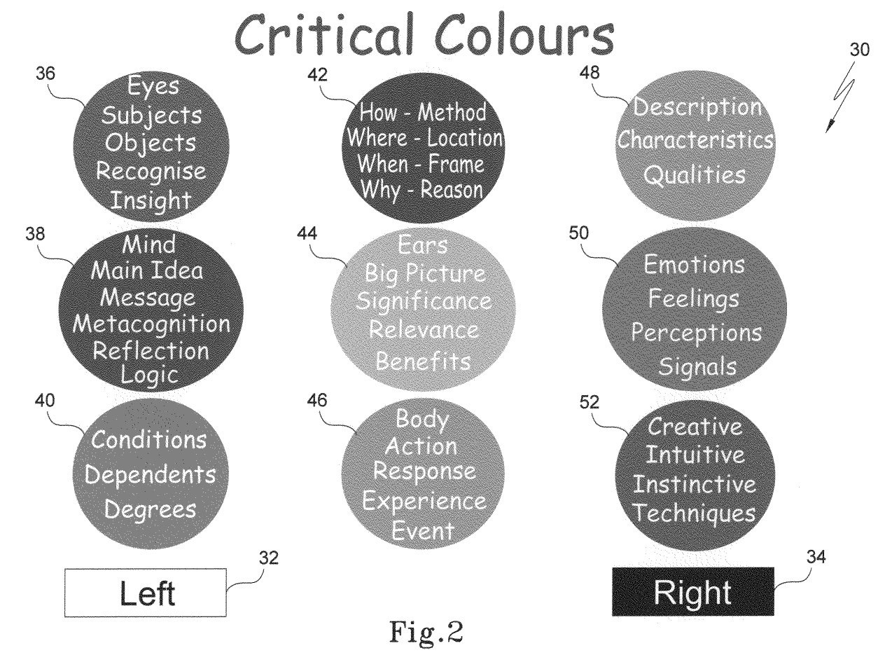

Underlying the system 10 are two aspects, one being the structured symbols 12 and the other being the use of predetermined colours representing aspects of the system 10. A representation of a colour chart is shown in FIG. 2 of the drawings and is designated generally by the reference numeral 30. As illustrated, the colours are grouped according to a left hemisphere of the brain as indicated at 32 and a right hemisphere of the brain as indicated at 34.

The colours are used as a tool which categorises concepts through the symbolic use of colour. The use of colour and the structured symbols enhance retention. Colour relationships are embedded throughout each module of the system 10.

The system 10 uses the structured symbols 12 to achieve cognitive engagement. The structured symbols 12 link concepts to the analytical mind and a relationship to an emotional memory. The use of the structured symbols 12 links symbolism to function to activate the analytical left side of a student's brain while the symbols with a real-world symbolic relationship activate the emotional right side of the student's brain. Thus, the structured symbols 12 link and activate physical, emotional and analytical learning using the eyes, ears, body and mind. More particularly, the ears physically listen to a symbolic story as told through the structured symbols 12, the eyes physically see the structured symbols 12 and the body physically manipulates the structured symbols 12 to link and activate physical, emotional and analytical learning.

In the colour chart 30 of FIG. 2 of the drawings, concepts relating to subjects, objects etc. are grouped together in a green coloured circle 36, the principal idea of a piece of work and other related concepts are grouped together in a blue coloured circle 38. Conditionality concepts are grouped together in a grey circle 40. Concepts relating to adverbs and adverbial phases are grouped together in a brown circle 42, concepts relating to significance and relevance are grouped together in a yellow circle 44 and concepts indicating action are grouped together in an orange circle 46. Concepts relating to characterisation and qualities are grouped together in a pink circle 48, concepts relating to emotions and feelings are grouped together in a red circle 50 and concepts relating to creativity and technique are grouped together in a purple circle 52.

In addition to the display means 14 referred to in FIG. 1 above, an interactive whiteboard (not shown) is provided on which a teacher and the students can manipulate the structured symbols 12 during construction and deconstruction of learning objectives. Symbols 12 from each of the modules are used during lessons to increase analysis and application. Visual, auditory and tactile reinforcement are supported by using the interactive technology.

The multisensory learning approach used by the system 10 is based on the premise that one's senses, in particular visual and auditory senses, are used to interpret and create works.

The structured symbols 12 logically link symbolism to function and activate the left side of the brain. These symbols 12 are personified symbols in the sense that they represent parts of the human body, the human body itself, items associated with the human body or used by people or reflect human characteristics such as strength, fear, concern, or the like. Personified symbols with a relationship aspect activate the right, creative side of the brain. Thus, both the left side of the brain and the right side of the brain as indicated at 32 and 34 of FIG. 2 of the drawings are activated when using the system 10.

Referring in greater detail to the structured symbols 12, the structured symbols 12 visually illustrate a concept. The symbols are characterised by recognisable objects connecting prior knowledge. Generally, as described above, these recognisable objects relate to the human body and are thus personified symbols. However, cultural and historical context are also symbolically represented. In particular, the structure of the symbols has a logical link to the function of each concept. Also, as described above, the use of the symbols is consolidated and enhanced by the association of the symbols, or parts thereof, with the relevant colours from the colour chart 30. In so doing, the structured symbols 12 prompt an emotional association. They also physically assist in enhancing the understanding of abstract concepts.

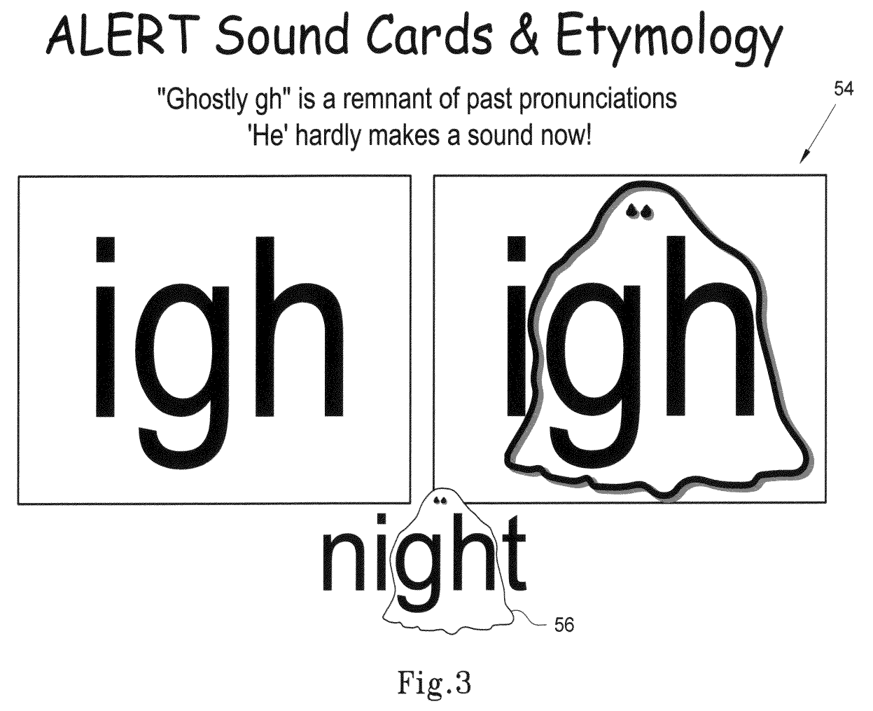

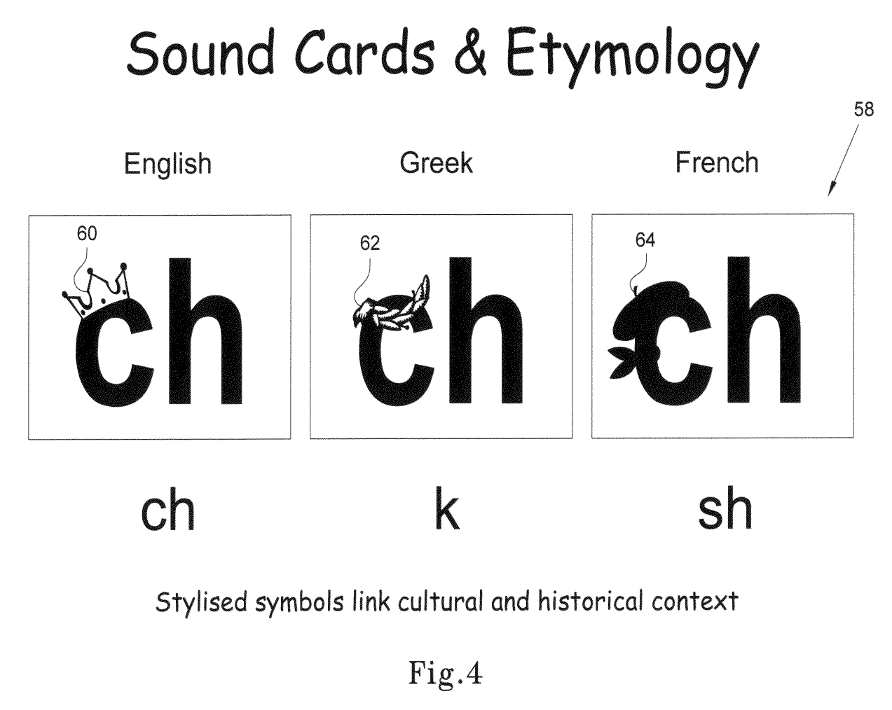

Dealing now with the relevant modules, the phonics module makes use of the user interfaces 14 to represent the combinations of letters which are used to make one sound. For example, as illustrated in FIG. 3 of the drawings, a card (which will generally be electronically implemented but may, in addition be a physical card) is provided, as illustrated at 54 to show the use of the silent “gh” using a ghost-like symbol 56 to indicate that the “gh” is not heard when pronouncing the word “night”. Similarly, a card 58 is provided which shows the different etymologies of the combined letters “ch” as they generally are used in English, Greek and French. This links cultural and historical context of the etymology by use of appropriate symbols 60, 62 and 64 for the English, Greek and French context of the sounds.

The phonic sound cards 54 and 56 symbolically represent the function of letters. By use of the structured symbols, the letters are personified and come to life in a manner to foster understanding of the current and/or historical roles of specific combinations of letters. Similar cards are used to indicate the relationship between the letters “i” and “y”, for example, and that there is a family relationship or tie between these letters. Personified symbols are used to show that, for example, original English words do not end with the letter “i” and generally end with the letter “y”. Thus, the rules of English are simplified and are easier to remember when the letters are personified using the structured symbols which support the function of letters in words.

Teaching of the phonics module is done by the selection of a number of sound cards with the teacher encouraging the students to see and say the words to promote accurate articulation of the relevant words. Another way of teaching is for a number of sound cards to be selected and the teacher says the sounds and the students record the sounds, for example, by typing them into their computers 20 or by writing them so that visual reinforcement is provided.

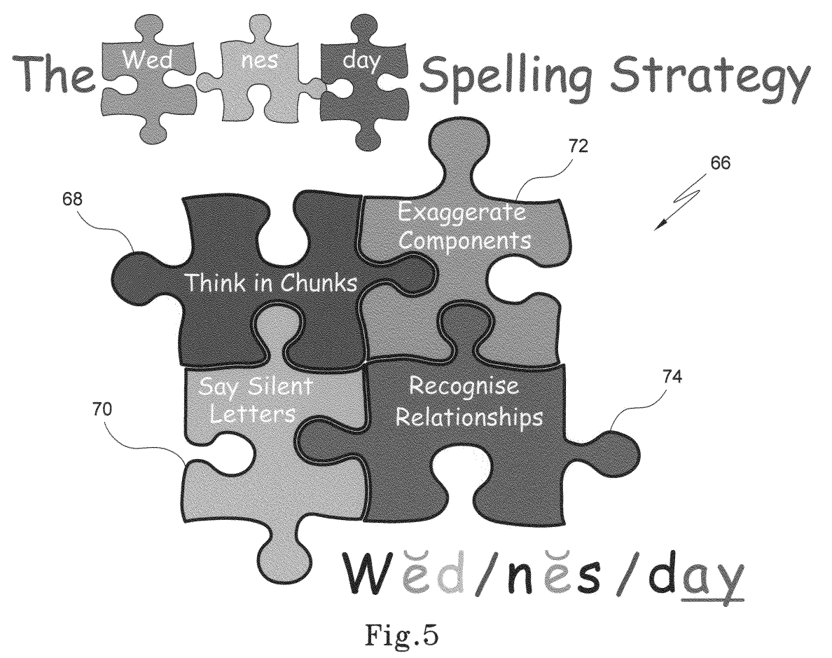

With reference to the spelling module, as shown in FIG. 5 of the drawings, use is made of what is referred to as a “Wednesday” strategy and is represented at 66. The “Wednesday” strategy makes use of jigsaw puzzle shaped pieces or symbols 68, 70, 72 and 74. The piece 68 is a blue piece, the piece 70 is a yellow piece, the piece 72 is an orange piece and the piece 74 is a green piece with the colours having the relevance assigned to them in the colour chart 30 referred to above.

The “Wednesday” strategy encourages a word to be broken down into “chunks” which may or may not be related to the syllables of the word. For example, although the word “Wednesday” only has two syllables it is more logical to break it into three pieces or chunks for spelling as illustrated in FIG. 5 of the drawings. This strategy further encourages exaggeration and articulation of the chunks, including saying the silent letters to increase auditory learning. The strategy also recognises letter relationships and how a vowel at the end of a syllable can change the sound of another vowel in the syllable and what the best choice of a suffix of a word would be. For example, in the word “destroy” a student is taught that the appropriate ending for a word is the letters “oy” at the end of the word rather than “oi”.

A number of the symbols 12 are set out in FIG. 6 of the drawings. These include the ghost symbol 56 and also symbols associated with particular letters as shown at 76 in FIG. 6 of the drawings. Thus, there is an “e” symbol with a wizard's hat 78 and a wand 80, another with muscular arms 82, a further with a wizard's hat 84 and wand 80, an “e” symbol with an ideas light bulb 86, an “e” symbol with a schoolboy's cap 88, an “s” symbol depicted as a snake 90 and a further “e” symbol with a hand raised to indicate “stop”.

Other symbols depicted include a combination of letters “q” and “u” to indicate that these are always used together, a number of knight symbols 96 and a medieval castle symbol 98. This list of symbols illustrated in FIG. 6 of the drawings is merely illustrative of some types of symbols and is in no way exhaustive. Other symbols with personification applied thereto are also included in the module.

The use of the wizard's hat 78 and wand 80 with vowel symbols is particularly to show that vowels can perform functions which consonants cannot do, in other words that vowels have “magical powers”.

It is to be noted that the wizard's hat 84 has two stars 100, 102 above it. The star 102 has the letters “C” and “G” in it. This is to depict that, when used with vowels and the letter “y”, the structured symbol in question changes the sound of neighbouring consonants such as changing the pronunciation of the letter “c” to sound like an “s” and the letter “g” to sound like the letter “j”.

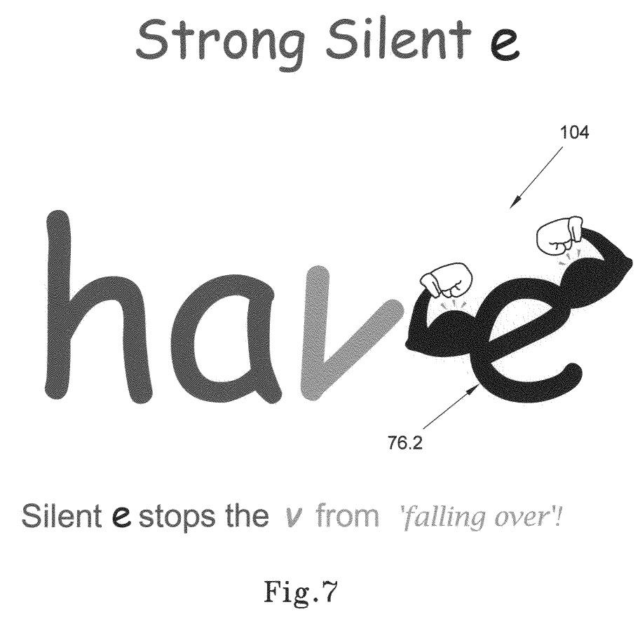

An example of the use of the symbols 76 is that when a symbol 76.1 is used in a word such as the word “mate” it shows that the “e” causes the letter “a” to adopt a long sound. Another example of the use of one of the structured symbols 76.2 is shown at 104 in FIG. 7 of the drawings where the structured symbol 76.2 is used at the end of the word “have”. The letter “v” in “have” is coloured orange and the “e” symbol is depicted as preventing the letter “v” from falling over, hence the depiction of the symbol as having strength, but which, itself, has no sound and does not change the pronunciation of the “a” in “have”.

A further example of the use of the structured symbols 76 is the use of the structured symbol 76.3 having the wizard's hat 84 with two stars 100 and 102 on it. When this structured symbol 76.3 is used in the word “dance”, for example, the symbol shows that the letter “c” is pronounced as the letter “s”. Similarly, for example, when the structured symbol 76.4 with the raised hand 92 is used in the word “horse” it is to depict that the neighbouring structured symbols 76.5, being the snake-shaped “s” 90 is prevented from “sliding away” by use of the structured symbol 76.4, i.e that there is a further symbol after the letter “s”.

In teaching spelling, a medieval metaphor is used. Stylised symbols are used to bring the language to life through a cultural perspective. Example of the stylised symbols are shown at 96 and 98 in FIG. 6 of the drawings. English spelling is taught using symbols that represent medieval England and the symbols support the timeframe in history in which the English language underwent significant development. The simple images, as depicted in the symbols 96 and 98, for example, tell a story which supports spelling rules and generalisations. The spelling is thus brought to life using the world of castles, knights and the wizard symbols as depicted at 76 in FIG. 6 of the drawings.

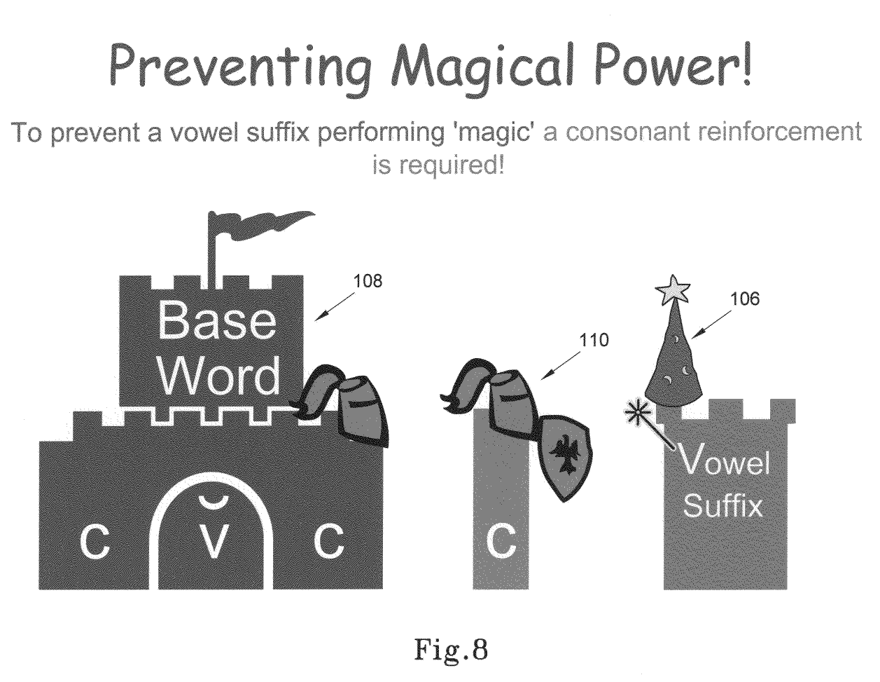

With reference to the symbol 98, it shows the base word and the possibility that the base word can be combined with prefixes and/or suffixes. The base word is coloured blue, the prefix part is coloured green and the suffix part is coloured red. An example of the use of the symbols 96 and 98 is shown in FIG. 8 of the drawings. A wizard suffix 106 is shown being blocked from a base word 108 by a knight symbol 110 representing a consonant. This sound card teaches that, for example, in the word “hopping” when an “ing” suffix is added to a single syllable word with one short vowel followed by one consonant, a further consonant, the second “p” in this case, is required to prevent the suffix changing the pronunciation of the vowel in the base word. To prevent this “magic” being performed on the vowel, a second consonant, represented by the symbol 110, is added.

In this way, a dynamic, exciting manner of teaching spelling is provided which promotes retention by students.

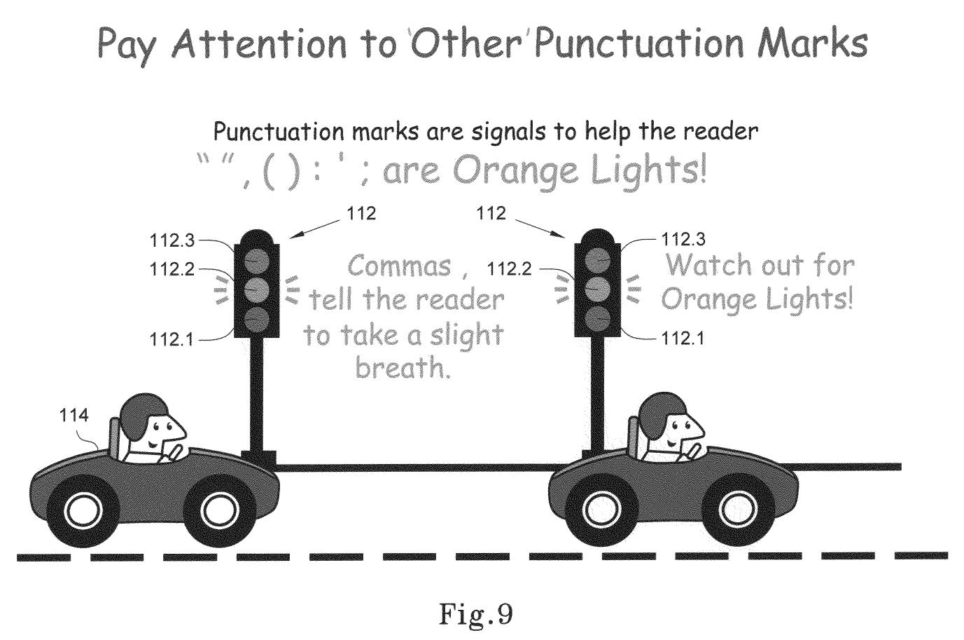

Referring now to FIG. 9 of the drawings, the reading module of the system 10 is described. The reading module makes use of “traffic lights”, for example, as shown at 112 to assist a student with reading. This assistance is enhanced by using a real world object for symbolically signifying the purpose of punctuation. The “traffic lights” 112 function as monitoring devices and have a green light 112.1, an orange light 112.2 and a red light 112.3.

The green lights 112.1 signify capital letters at the beginning of a sentence, orange lights represent commas to tell the reader to take a slight breath. Other punctuation marks signified by the orange lights 112.2 are quotation marks, brackets, colons, apostrophes and semi-colons.

The red lights 112.3 of the traffic lights 112 are end punctuation signals such as full stops, question marks and exclamation marks that tell the reader that they have reached the end of a sentence, to take a breath and monitor their understanding of what was contained in the sentence just read. In the case of dynamic slides displayed on the screen 18 of the computer 20 or the screens 28 of the student's computers 26, a motor vehicle, as illustrated schematically at 114 is used and crosses a green starting line to show the start of a sentence and crosses a red finishing line signifying the end of a sentence. These lines are omitted from FIG. 9.

Additional strategies taught by the reading module encourage students to say the word out loud, try the most common sounds first and then try additional sounds in order. Words or groups of letters in words having particular sounds can be underlined on the cards 16. Students are also taught the use of silent letters which changes the sound of others letters in the word such as has been described above with reference to the spelling module. The spelling module is, therefore, also used in the reading module and, for example, students are encouraged to break words into syllable chunks, identify irregular words, highlight end punctuation, for example, by circling it and checking for understanding at the end of a sentence. The various strategies outlined above are incorporated on the cards 16 of the user interfaces 14 as well.

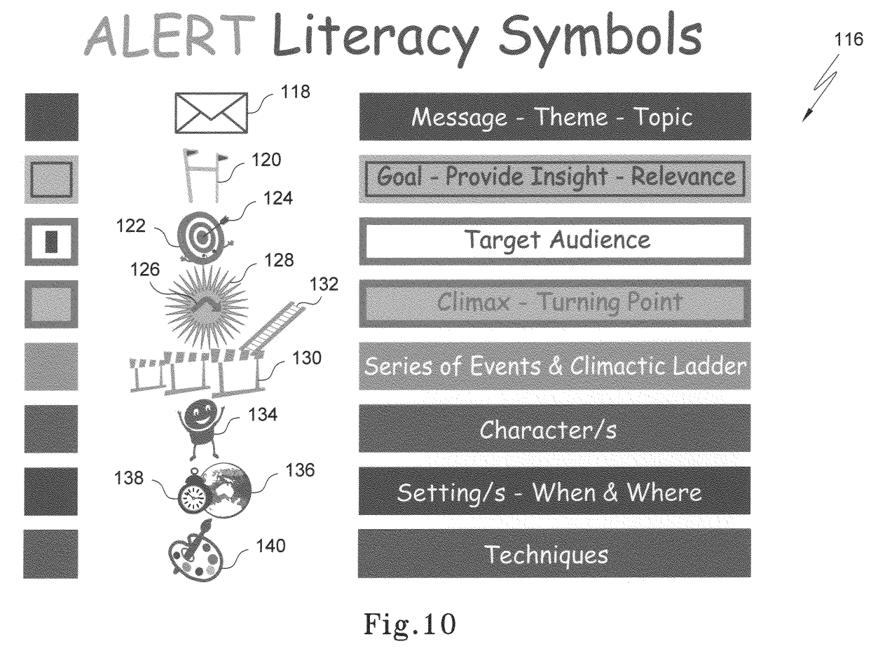

The comprehension module of the system 10 makes use of literacy symbols as illustrated at 116 in FIG. 10 of the drawings. Further, the comprehension module makes use of the multisensory technique of listening, looking, linking and learning. Students are encouraged, not only to read what is on the lines but, symbolically, to read between the lines and read beyond the lines by means of appropriate cards.

The literacy symbols 116, once again, make use of well known symbols, suitably colour coded in accordance with the colour chart 30. Thus, the main message is shown as a blue envelope 118. The goal of the piece of writing is shown as yellow goalposts 120, the target audience is shown as a red target 112 with a blue arrow 124. The climax of the piece of writing is shown as a red arrow 126 on a sun-like symbol 128 having a yellow background with a red border. A series of events is shown as orange hurdles 130 and/or a ladder 132. Characters in the work are shown as green human-like creatures 134, the setting of the piece of work is shown as a brown globe 136 and a brown clock 138. Finally, the techniques to be employed are shown by a symbolic, purple painter's brush and pallet 140. Further, a magnifying glass (not shown) is used to signify clues surrounding the climax or turning point represented by the arrow 126.

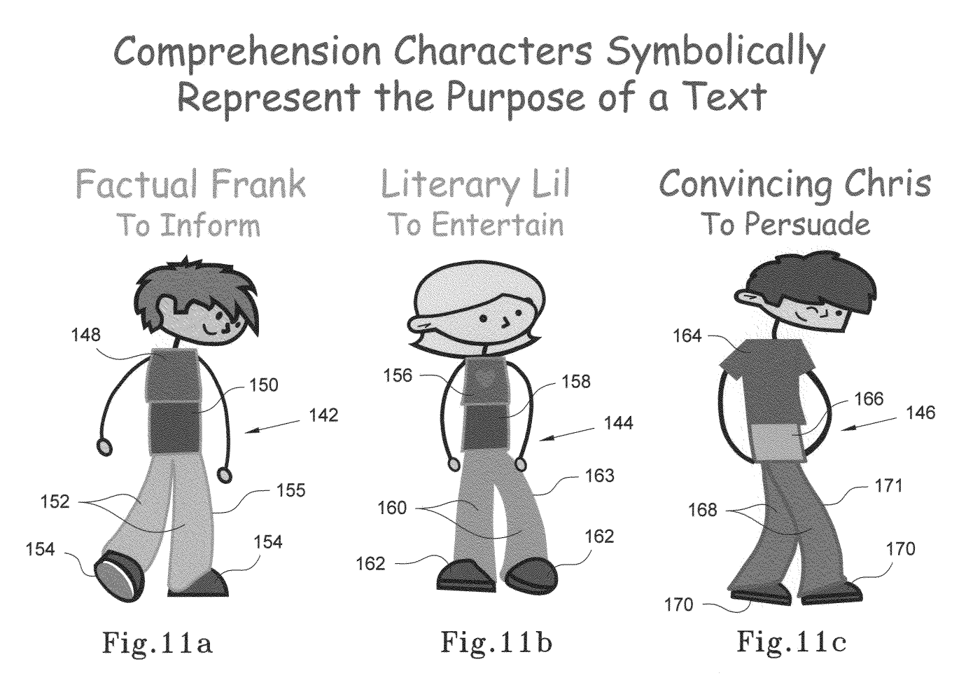

Another feature of the comprehension module is the use of comprehension characters to symbolically represent the purpose of a text. The comprehension module includes three comprehension characters 142, 144 and 146 (FIGS. 11a-11c).

The comprehension character 142 is named “Factual Frank”. The purpose of this comprehension character is to inform, explain or instruct. Information associated with this character 142 is always in a logical order and requires structure to get the point across. The type of text which is informative requires an introduction, facts, evidence, details and a conclusion. The language used is precise, informative and subject-specific with the information being supported with accurate proof. The text is generally written in the third person to remain objective and is written in the present tense. The types of texts associated with the “Factual Frank” character 142 include, but are not limited to: Explanation, Factual description, Factual essay, Factual recount, Information report, School report, Procedure, Documentaries, Graphs, Maps, Tables, Diagrams, or the like.

The Factual Frank character 142 has a green, upper torso 148 a brown, lower torso 150, yellow legs 152, blue feet 154 and an orange outline 155. Once again, these colours have the meanings assigned to them in the colour chart 30.

The character 144 is named “Literary Lil” and the purpose of this character is to entertain using imaginative text types. Thus, the character 144 is intended to entertain by appealing to the reader's emotions. The goal of this type of text is to develop an understanding about people and the world. The text uses a range of literary techniques that bring characters to life and help the reader to understand their experiences. The type of text represented by the Literary Lil character 144 requires language that activates the imagination, is expressive, emotional, dramatic, vivid, sensitive, meaningful and significant. In other words, the language is sensory language to stimulate the reader's senses. The types of texts associated with the “Literary Lil” character 144 include, but are not limited to: Literary descriptions, Literary accounts, Narratives, Traditional tales, Fables, Legends, Myths, Poems, Ballads, Dialogue, Plays/Scripts, Song Lyrics, Movie scripts, Comic Strips, or the like.

The Literary Lil character 144 has a green, upper torso 156, a brown, lower torso 158, orange legs 160, blue feet 162 and a pink outline 163.

The character 146 is named “Convincing Chris” and is a personification of a persuasive text type, the purpose of the text being to persuade, convince or argue. This text type is organised with a logical structure. Personal bias is concealed and use is made of subtle, persuasive techniques. This type of text uses specific language, layout and graphic techniques to convince an audience. The arguments are presented by stating an issue and using supporting evidence for different perspectives. The purpose of this text is revealed by scrutinising language choices which attempt to influence the responses of a particular audience. The types of texts associated with the “Convincing Chris” character 146 include, but are not limited to: Advertisements, Arguments, Debates, Discussions, Documentaries, Expositions, Feature articles, Letters e.g. to the editor, Magazine covers, Pamphlets & Posters, Personal responses, Persuasive essays, Reviews, Speeches, or the like.

The Convincing Chris character 146 has a green, upper torso 164, a yellow, lower torso 166, red legs 168, blue feet 170 and a purple outline 171.

Generally, in the comprehension module, components of each text are symbolically represented using the literacy symbols 116 described above. These symbols are displayed, in an appropriate format, on the user interfaces 14. When the cards are displayed dynamically on the displays 18, 28 of the computers 20, 26 respectively, a representation is shown of how the characters can change through experiences. The use of personification helps build a relationship with a target audience.

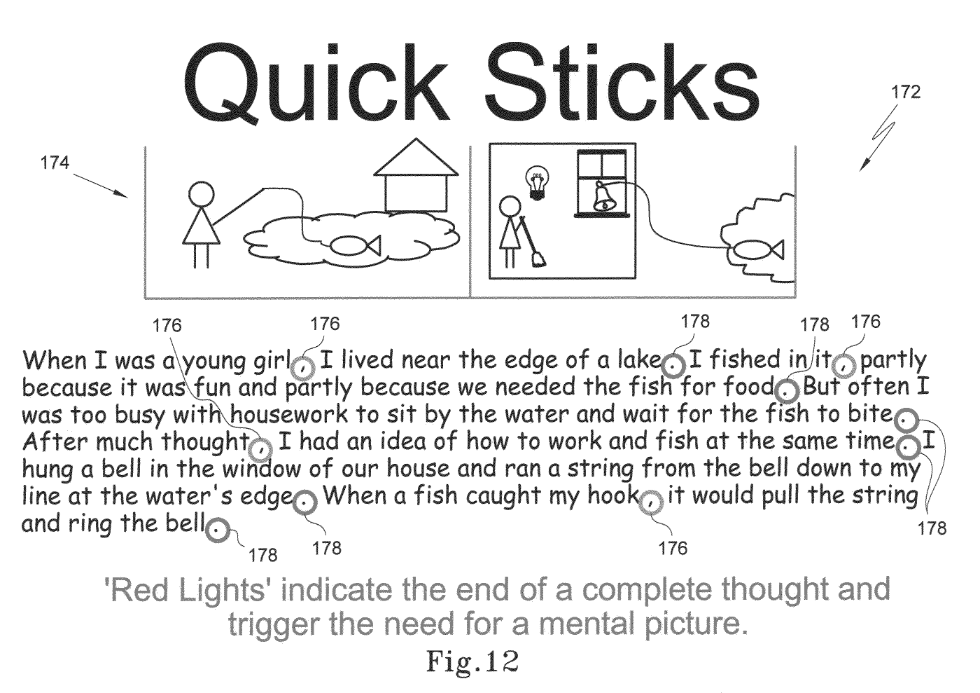

In the comprehension module, use is also made of a concept known as “Quick Sticks” as shown by an example of such a display card at 172 in FIG. 12 of the drawings.

The Quick Sticks concept is a visualisation technique and uses rapid, symbolic representations, shown, for example at 174 to enhance comprehension. Thus, the concept of Quick Sticks is the use of simple, structured symbols to represent content quickly and easily. Students are encouraged to generate personal graphic representations of context.

In the comprehension module, the “traffic lights” 112 are integrated with the “Quick Sticks” technique 172. This technique engages the eyes, ears, body and mind to enhance physical, emotional and analytical learning. The punctuation marks are highlighted with orange circles 176 for mid-sentence punctuation and red circles 178 to indicate end of sentence punctuation.

In the comprehension modules students are encouraged, by way of the user interfaces 14, to mark key words using the symbols from the grammar module to be described below.

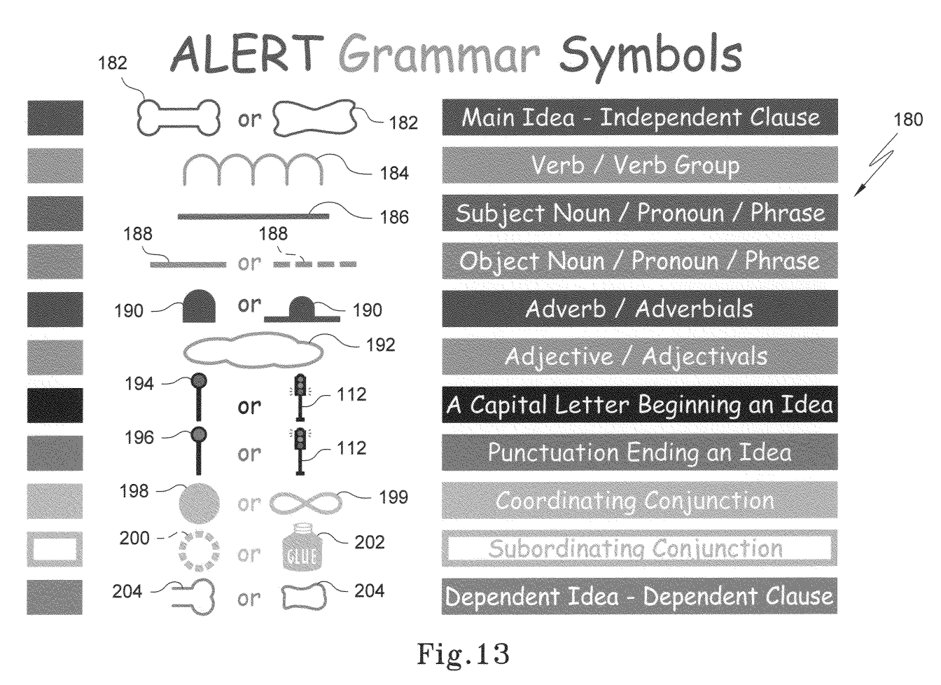

Referring now to FIGS. 13-16, the grammar module is described in greater detail. The grammar module makes use of grammar symbols 180 as shown in FIG. 13 of the drawings. The grammar symbols 180 are, fundamentally, based on the idea of using the body of a person and the parts of that body to build up a structure to show how a sentence is constructed.

The symbols 180 include a blue, bone symbol 182 which represents the main idea. The verb of the sentence is shown by mounds 184 representing marrow of the bone 182. The subject noun and object noun of a sentence are represented by green lines 186 and 188, respectively, the green lines 186 and 188 being of different shades of green. Adverbs are shown by brown bulbous symbols 190 while adjectives are shown by a pink, cloud symbol 192. Using the traffic light concept described above, capital letters at the beginning of a sentence are shown by traffic lights 112 or a green, lollipop symbol 194. Similarly, punctuation at the end of a sentence is shown by a red traffic light 112, a red, lollipop symbol 196 or a red stop sign symbol (not illustrated in FIG. 13). Coordinating conjunctions are shown by a yellow circular symbol 198 or an infinity symbol 199. Subordinating conjunctions are shown by a phantom line circular symbol 200 or by a symbol 202 representing a pot of glue. A dependent idea or clause is shown by a grey bone portion symbol 204.

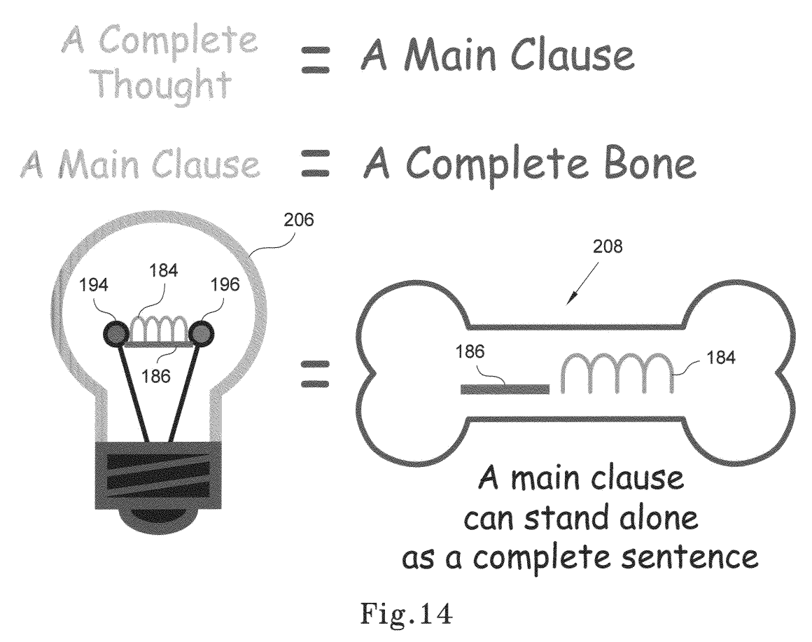

A further card, as illustrated in FIG. 14 of the drawings shows how a complete thought, as illustrated by a light bulb 206, translates into a complete sentence as represented by the bone 208. The light bulb 206 has the start symbol 194 representing the beginning of the sentence, the mounds 184 representing the verb of the sentence, the green line 186 representing the subject of the sentence and the red symbol 196 representing the end of the sentence. When translated into the bone symbol 208, the component parts are separated out to show the main subject 186 of the sentence and the verb 184 of the sentence.

So, for example, the sentence “Jo read a book” would be illustrated on the user interface 14 as having the subject, “Jo”, in dark green, the verb “read” in an orange colour and the object of the sentence “a book” in green but a different shade of green to the subject. The full stop at the end of the sentence is shown in red.

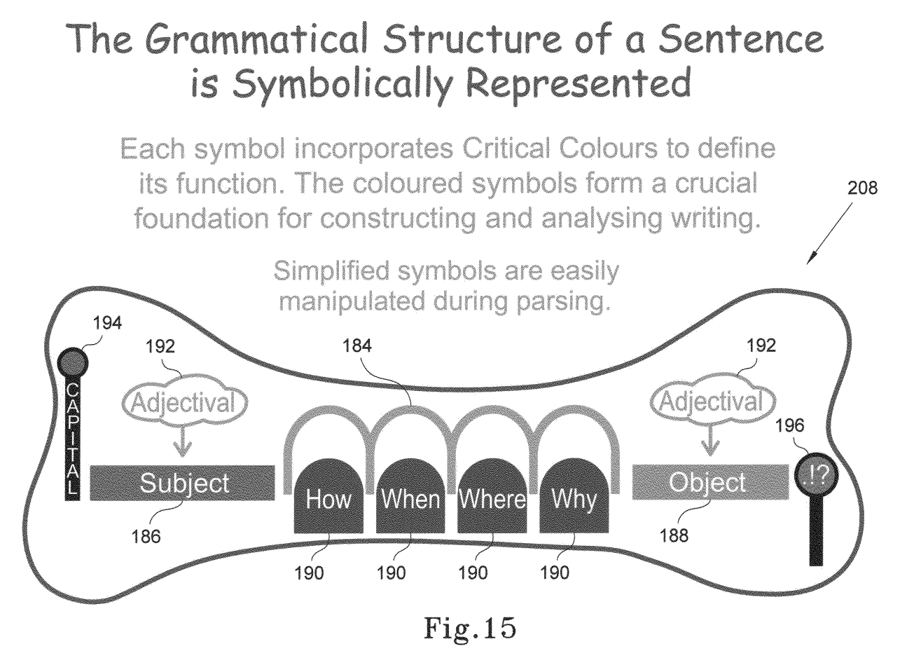

As illustrated in FIG. 15 of the drawings, a more complex sentence can also be symbolised by the bone-like symbol 208. The grammatical structure of a sentence is, therefore, symbolically represented with the symbols incorporating the critical colours of the colour chart 30 to define the function of the parts of the sentence. These colours therefore form a foundation for constructing and analysing. The simplified symbols are easily manipulated during parsing.

Thus, a more complex sentence is shown by having a capital letter starting the sentence using the symbol 194. The subject noun is shown by the green line 186. An adjectival clause or adjective is shown by a pink cloud 192 associated with the subject noun 186. The verbs are shown by the orange mounds 184 and adverbs or adverbial clauses associated with the verbs are shown by the bulbous symbols 190 representing “how”, “where”, “when” and “why”. The object noun is shown using the green line 188 and an adjectival clause associated with the object noun is represented using the pink cloud 192. The end punctuation is shown with the red symbol 196.

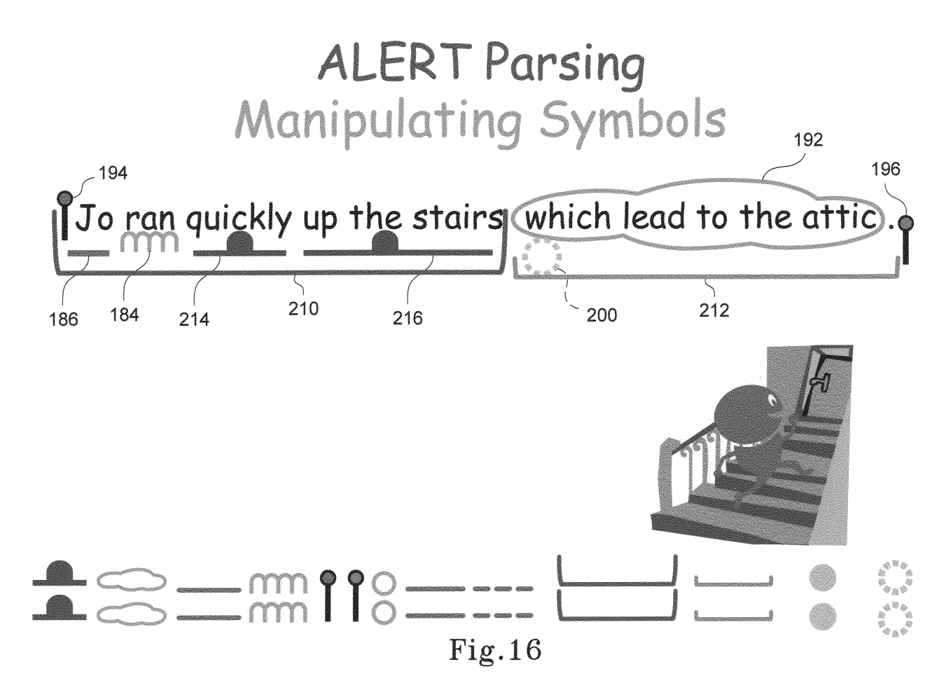

This module makes use of parsing for paring the sentence “back to the bone” to analyse the grammatical structure of a sentence. The parsing technique used in the grammar module makes use of symbols similar to those illustrated at 180 in FIG. 13 of the drawings. However, instead of the bone symbols 182 or 204, more simplified symbols are used as will be described below with reference to FIG. 16.

In FIG. 16 the sentence “Jo ran quickly up the stairs which lead to the attic” is used as an example of a sentence to be parsed. The main clause is represented by a blue, bracket symbol 210. The dependent clause is shown by a grey, bracket symbol 212 with the subordinating conjunction “which” being highlighted by the circle symbol 200. The beginning of the sentence is shown by the green symbol 194, the subject of the sentence is shown by the green line 186 and the verb is shown by the mounds symbol 184. In this case, the adverbs or adverbial clauses are shown by variations of the symbols 190 and, more particularly, by the symbols shown at 214 and 216 in FIG. 16 of the drawings. In the sentence being parsed, the dependent clause 212 is an adjectival clause and is shown in the pink cloud symbol 192. The end of the sentence is shown by the red symbol 196.

The writing module, once again, makes use of the human body as the basis for a unique method for teaching writing. As described above with reference to the grammar module, a complete sentence in a piece of writing is represented by a complete bone. At the core of the bone is the marrow or verb represented by the marrow mounds 184. As sentences develop and become more complex, bare bones become chunky bones once muscles, representing adverbs are added to them. The writing module makes use of the concept of simple bones, compound bones and complex bones which make up a body of text. Once again, the critical colours, as represented by the colour chart 30, are used.

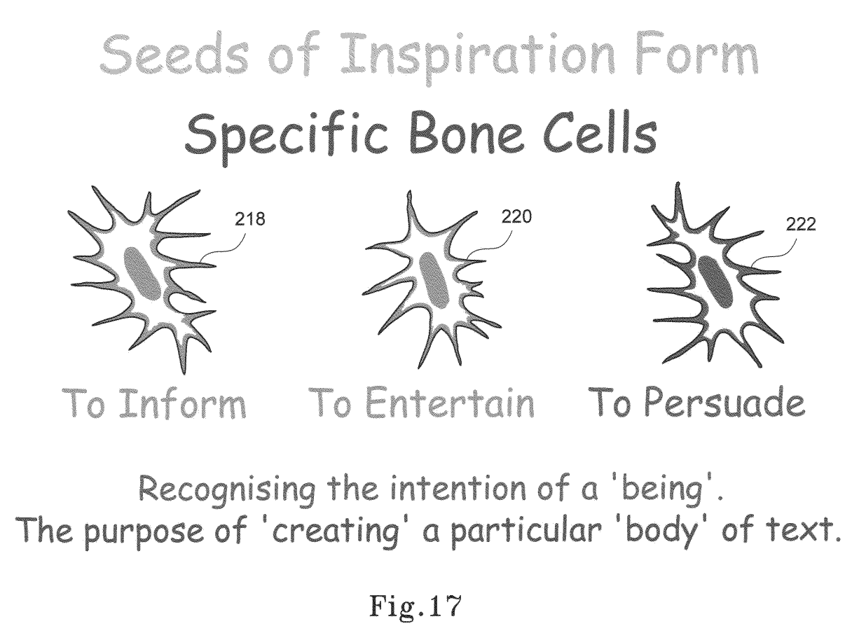

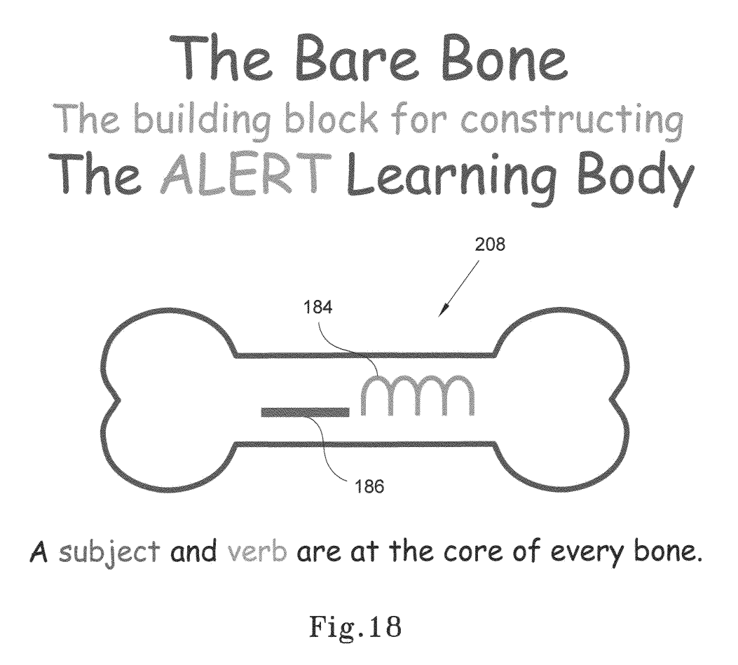

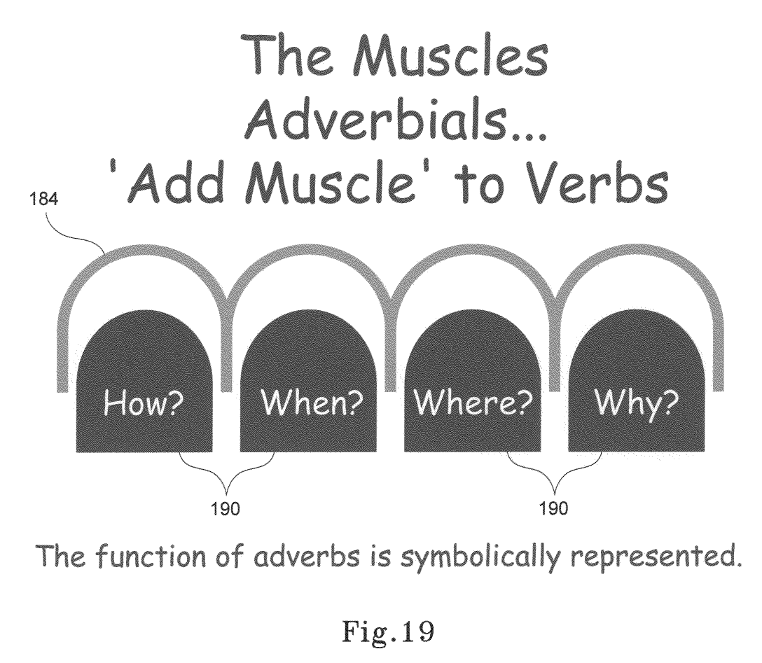

The idea of the use of the body is taken down to a cell level as shown at FIG. 17 of the drawings where bone cells 218, 220 and 222, being orange, pink and purple, are used to inform, to entertain and to persuade, respectively.

Thus, the writing module makes use of the concept of the basic foundation being the bone cell, leading to the marrow, the bare bones, the muscles and the various types of bones. From this, a human hand, having fingers and finger bones can be generated and, similarly, a body having a head, upper torso, middle torso, legs and feet are generated. The nervous system is also included to represent the grammar used in a piece of text.

As described above, the mounds 184 are used for verbs as they represent a sense of action particularly when represented dynamically using the computers 20, 26. The mounds 184 also serve as a memory trigger for adverbs or adverbial clauses. In addition, the concept of using the verbs as marrow of a bone represent that a verb is an essential part of a sentence and that a sentence cannot exist without a verb.

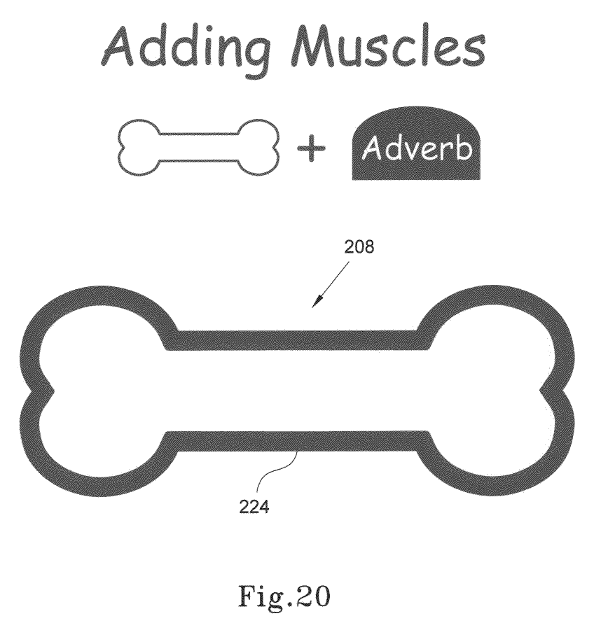

As was the case with the grammar module described above, the writing module also makes use of the bone symbol 208 with the subject symbol 186 and the verb symbol 184. The verb symbol 184 is supplemented by the bulbous symbols 190 to remind the writer of the function of adverbs and to represent adverbs symbolically. Using the human body as the concept, the adverbs “add muscle” to the verbs. Thus, the bone symbol 208, as shown in FIG. 20 of the drawings is enhanced and built up as shown at 224 to represent the “muscle” added to the sentence.

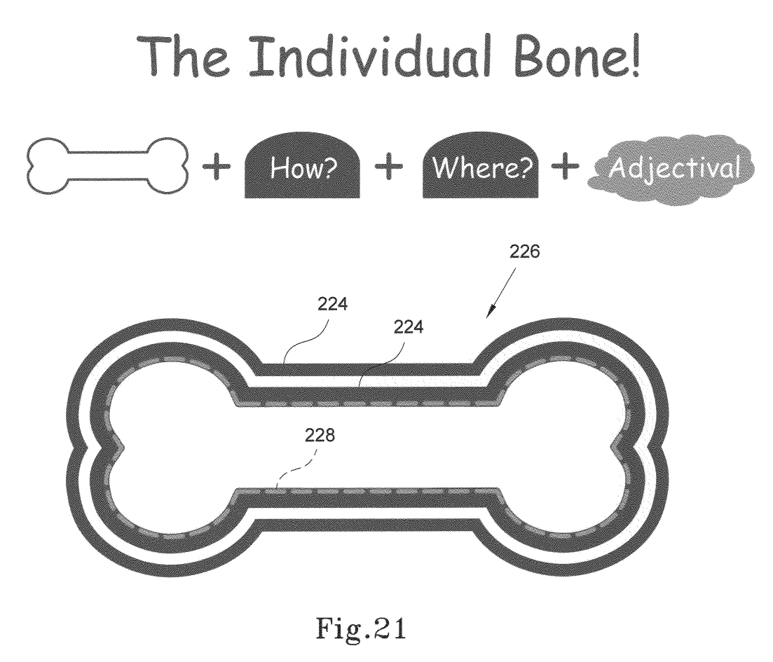

A more complex bone is shown at 226 in FIG. 21 of the drawings having multiple layers 224 representing adverbial clauses or adverbs in the sentence. Adjectival clauses are represented by the pink dotted line 228 in the bone.

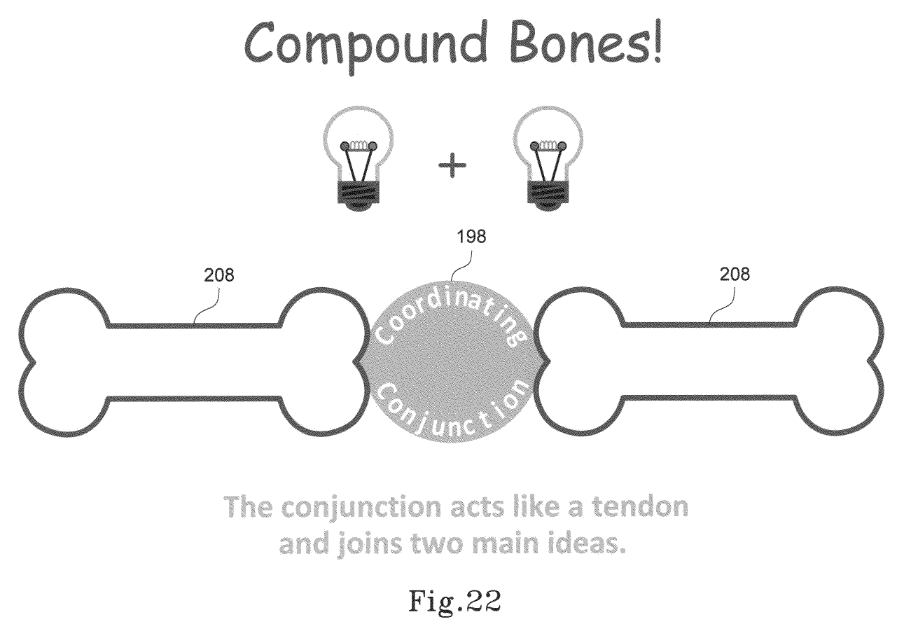

Referring to FIG. 22 of the drawings, a compound bone idea is illustrated. This illustrates the use of the coordinating conjunction 198 between two sentences or main ideas represented by the bones 208. Using this technique, the purpose of the conjunction 198 is learnt by the students.

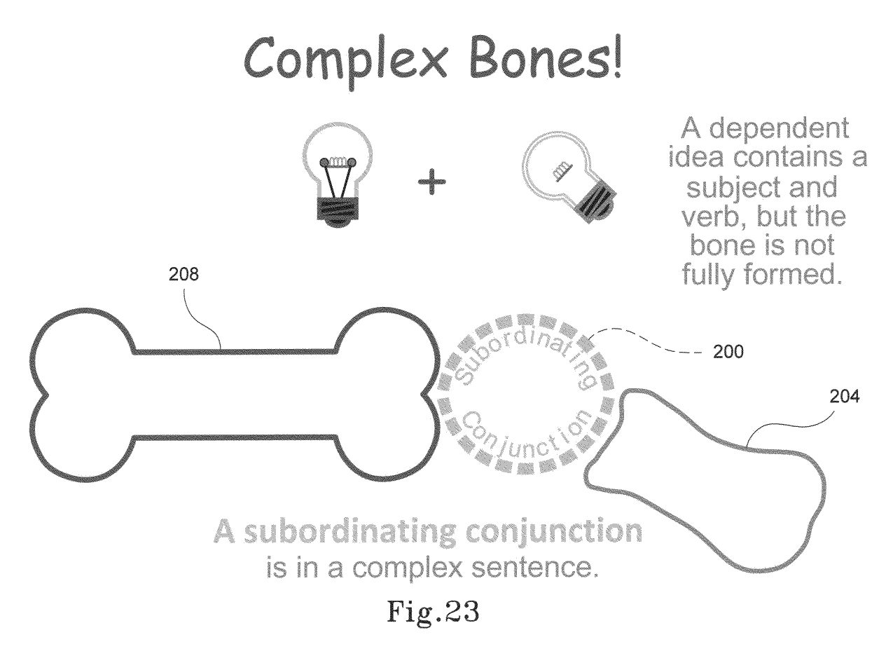

A complex bone is shown in FIG. 23 of the drawings where a main idea or sentence 208 is joined via a subordinating conjunction 200 to a dependent idea represented by the symbol 204 being a part of the bone as described above.

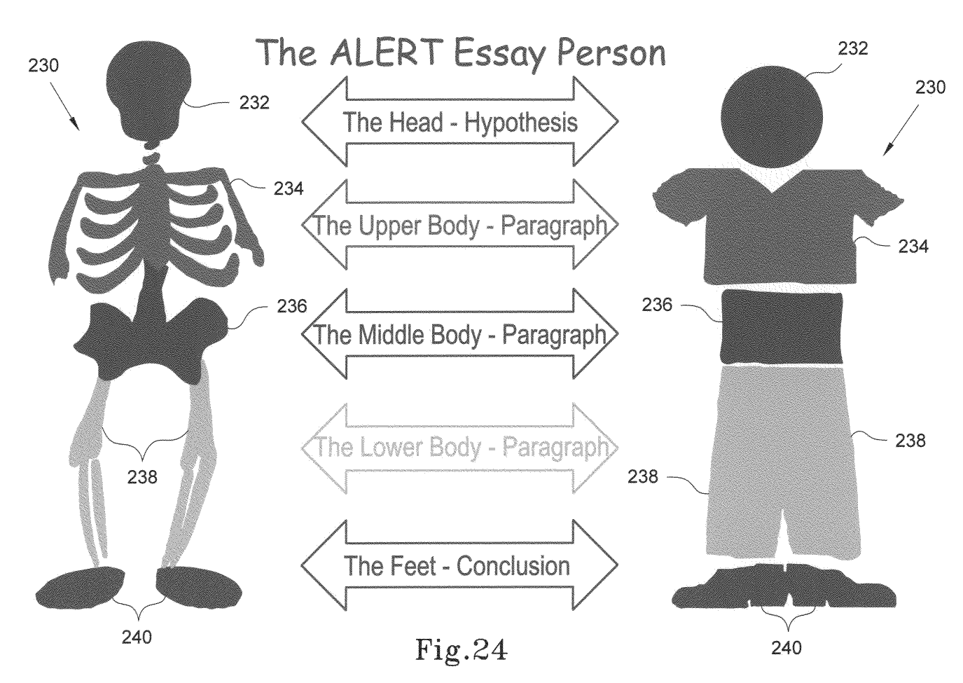

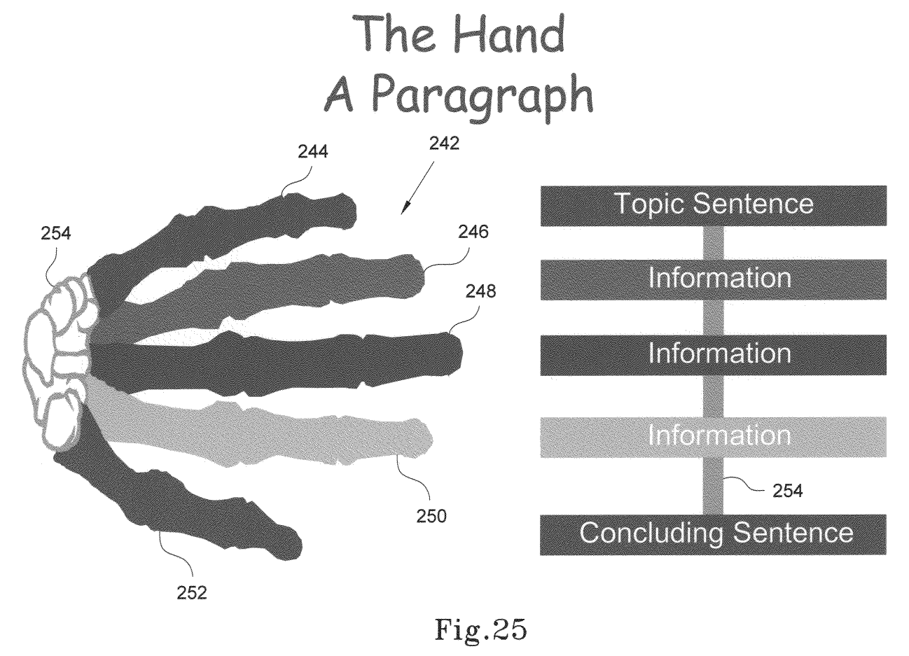

As described above, the writing module makes use either of a hand or of a symbol representing the human body as shown at 230 in FIG. 24 of the drawings to show the component parts of an essay or a paragraph of an essay. The symbol 230 can either be a skeleton or a clothed human body. The essay body shows that an essay typically has a hypothesis illustrated by a blue head 232, three body paragraphs represented by an upper torso 234, a lower torso 236 and legs 238. A concluding paragraph of the sentence is represented by blue feet 240. The colours of the upper torso 234, the lower torso 236 and the legs 238 will vary dependent on the purpose of the essay. The selected colours serve as a simple reminder of what is contained in an essay. For example, as illustrated, a factual essay has a green upper torso 234, a brown lower torso 236 and yellow legs 238. A persuasive essay has a green upper torso 234, a yellow lower torso 236 and red legs 238.

This multisensory method of teaching essay structure animates the writing process using personification. The structured symbols 230 are related to a real-world physical structure readily recognisable to the student and which simplifies essay writing.

Instead of a body symbol 230, the essay can also be represented by a hand where the first and fifth fingers are both blue and the colours of the second finger, the third finger and the fourth finger will depend on the purpose of the essay represented by the hand symbol. For example, for a factual essay, the colour of the second finger is green, the colour of the third finger is brown and the colour of the fourth finger is yellow.

While the entire essay is represented by a body symbol 230, a paragraph in the essay can also be represented by a hand symbol 242 having a blue, first finger 244 representative of a topic sentence of that paragraph. A green, second finger 246, a brown third finger 248 and a yellow fourth finger 250 are main body sentences of the paragraph conveying information to the reader and a blue, fifth finger 252 is a concluding sentence of that paragraph. Grammar in the paragraph is represented by an orange line 254. Once again, it will be appreciated that the colour of the second finger 246, the third finger 248 and the fourth finger 250 will change dependent on the purpose of the paragraph.

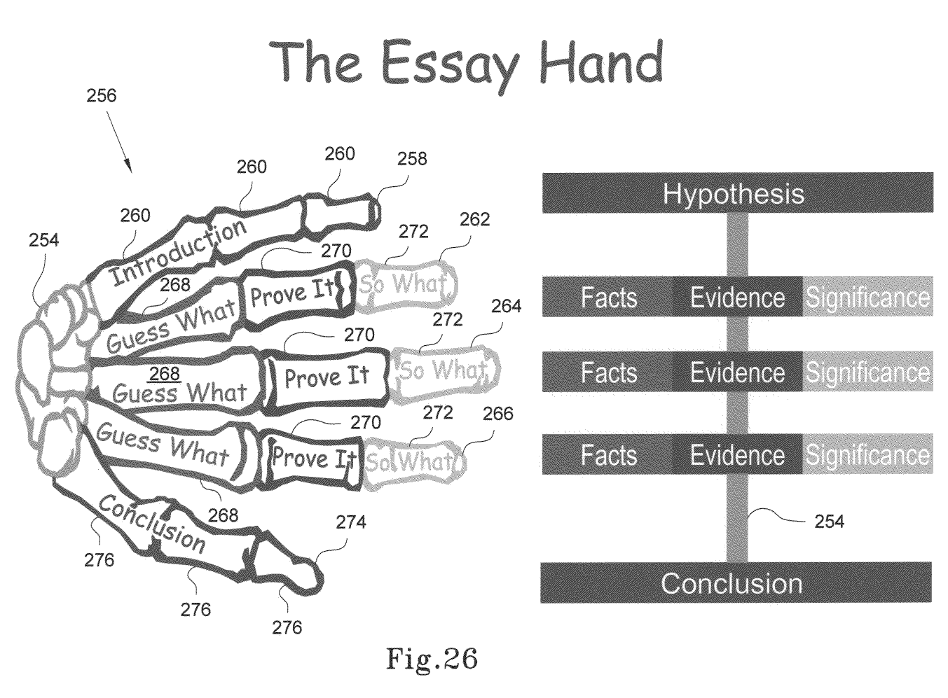

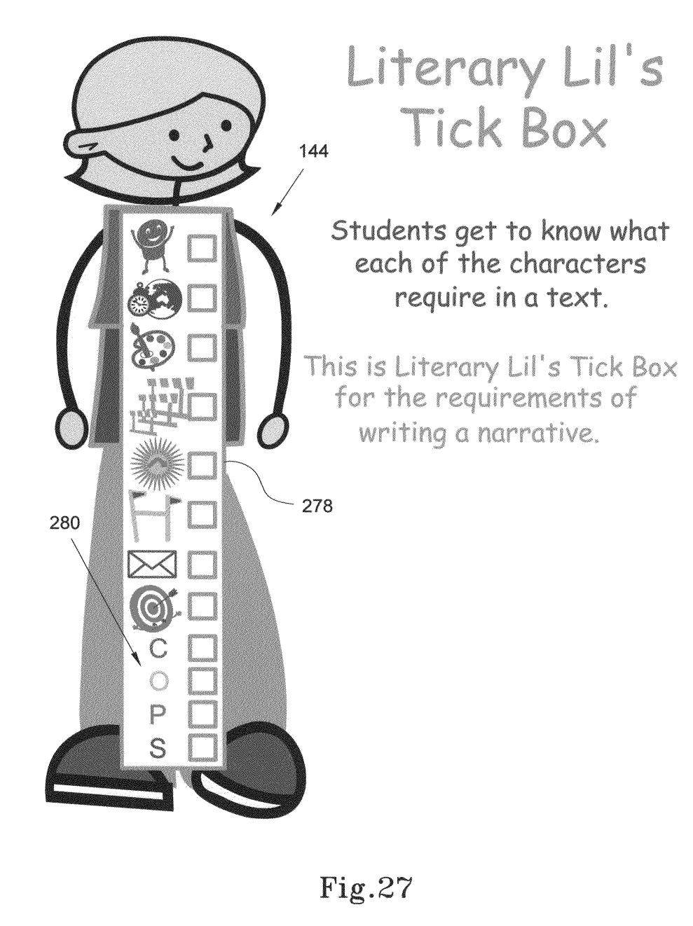

Reverting to the idea of a hand as an entire essay, an example of such a hand is shown at 256 in FIG. 26 of the drawings. A first finger 258 of the hand has its phalanges 260 all coloured blue representing the hypothesis being put forward in the essay.

The second finger 262, the third finger 264 and the fourth finger 266 each have their proximal phalanx 268 coloured green to represent information contained in the relevant paragraph of the essay. The middle phalanx 270 is coloured brown and represents evidence supporting the information in the paragraph and the distal phalanx 272 of each finger 262, 264 and 266 is coloured yellow representing the significance of the evidence presented. These colours will also change dependent on the purpose of the essay.

Finally, the fifth finger 274 of the hand 256 has all of its phalanges the same colour, being blue, to represent the conclusion of the essay.

Dealing finally with the editing module of the system 10, the Literary Lil character 144 is shown overlain with a check box 278. The editing module makes use of a “COPS” acronym signifying “capitalisation”, “organisation”, “punctuation” and “spelling”, respectively. The “COPS” acronym is shown at 280 in the check box 278.

In respect of capitalisation, information is provided as to where capital letters are needed in a sentence, not only at the start of a sentence but also for proper nouns, main words in headings, beginning of direct speech, etc. Organisational issues relate to whether or not there are complete sentences, varied and interesting sentences, correct spacing between the words and paragraphs, appearance, layout, etc. This concept is adapted from Strategies for Effective Learning and Thinking (Mulcahy, Marfo & Peat, 1984).

Checking punctuation involves appropriate use of punctuation at the end of sentences and in sentences.

Checking spelling involves sounding out what has actually been written, considering alternate sounds on the sound cards, checking the rules, checking homophones, considering the base words, etc.

The check box 278 enables a teacher or a student to check that all the component parts of a piece of writing are present by use of the appropriate symbols in the check box 278 as well as to enable checking of the piece of writing using the COPS acronym 280.

Finally, the editing process also make use of a “PATROL” acronym for proof reading written works. The acronym stands for “purpose”, “audience”, “techniques”, “readability”, “originality” and “language” provided in blue, red, purple, green, pink and yellow, respectively. These letters can, if desired, also be represented in the form of symbols wearing police hats of the appropriate colour.

It is therefore an advantage of the disclosure that a system 10 is provided which enables learning of a subject, for example, a language to be done in a multisensory way. The applicant believes that this will greatly enhance the learning process and that the techniques used will encourage retention of the material learnt by the students using the system 10. The system 10 also lends itself to being implemented electronically so it can be used for remote teaching.

The use of dynamic symbols also encourages retention of the subject being learnt by the students.

It will be appreciated by persons skilled in the art that numerous variations and/or modifications may be made to the disclosure as shown in the specific embodiments without departing from the scope of the disclosure as broadly described. The present embodiments are, therefore, to be considered in all respects as illustrative and not restrictive.

1. A computer implemented learning system which includes a database containing a plurality of structured symbols, each symbol being representative of a particular theme selected to enhance multisensory learning by a student; and a user interface for presenting the structured symbols to the student in a form discernible to the student.

2. The system of claim 1 in which the particular theme is a personification of the concept to be learnt, the symbols being associated with at least one of parts of the human body, the human body itself and items associated with the human body.

3. The system of claim 1 in which the personification of the structured symbols reflect human characteristics.

4. The system of claim 2 in which the personification of the concept to be learned is supported by the use of a symbolic story to assist in developing an emotional understanding of the concept.

5. The system of claim 1 in which the themes are colour coded to enhance categorising concepts.

6. The system of claim 5 which integrates the colours with the symbols to enhance retention, the colours being selected to have particular relationships.

7. The system of claim 1 in which each structured symbol comprises a plurality of interrelated components.

8. The system of claim 7 in which the components relate to a part of the human body.

9. The system of claim 7 in which each structured symbol is a part of the body.

10. The system of claim 7 in which each structured symbol represents a person.

11. The system of claim 10 in which a body of each person symbol comprises a number of discrete parts, each of which represents a different part of the concept.

12. The system of claim 11 in which specific colours are applied to the discrete parts of the body to reinforce learning.

13. The system of claim 1 which comprises a plurality of modules, the modules being able to be used in conjunction with one another or independently of one another, depending on the concept to be taught.

14. The system of claim 13 in which each module makes use of the personification of concepts and the symbolic representation of the personified concepts.

15. The system of claim 1 in which the user interface is an electronic display means on which the symbols can be displayed in a dynamic format.

16. The system of claim 15 in which the dynamic display of the symbols enables the action represented by the symbol or a component of the symbol to be emphasised.

17. The system of claim 1 which comprises cards on which the symbols are carried.

18. A computer implemented method of learning which includes personifying a concept to be learnt; representing the personified concept using a plurality of structured symbols to enhance multisensory learning by a student, the structured symbols being stored in a database; and presenting the symbols to the student in a form discernible to the student using a user interface.

19. The method of claim 18 which includes associating the symbols with at least one of parts of the human body, the human body itself and items which themselves are associated with the human body or which a person would use in a particular environment.

20. The method of claim 19 which includes supporting the personification of the concept to be learned by the use of a symbolic story to assist in developing an emotional understanding of the concept being learnt.

21. The method of claim 18 which includes colour coding the themes to enhance categorising concepts.

22. The method of claim 21 which includes integrating the colours with the symbols to enhance retention.

23. The method of claim 21 which includes selecting the colours to have particular relationships.

24. The method of claim 18 which includes generating each structured symbol to comprise a plurality of interrelated components.

25. The method of claim 24 which includes applying specific colours to the components of the structured symbol to enhance learning.

26. The method of claim 18 in which the user interface is an electronic display means and in which the method includes displaying the symbols on the electronic display means in a dynamic format to enable the action represented by the symbol or a component of the symbol to be emphasised.

27. The method of claim 18 which includes displaying the symbols on cards.

28. A learning system which includes a plurality of structured symbols, each symbol being representative of a particular theme selected to enhance multisensory learning by a student; and a display means for displaying the structured symbols to the student.

29. A method of learning which includes personifying a concept to be learnt;
representing the personified concept using a plurality of structured symbols to enhance multisensory learning by a student; and displaying the symbols in a form discernible to the student.
